(19) United States
(12) Patent Application Publication
(10) Pub. No.: US 2023/0334329 A1
(43) Pub. Date: Oct. 19, 2023

(54) MULTI-AGENT REINFORCEMENT LEARNING SYSTEM AND OPERATING METHOD THEREOF

(71) Applicant: Korea Advanced Institute of Science and Technology, Daejeon (KR)

(72) Inventors: Joo-Young KIM, Daejeon (KR); Je YANG, Daejeon (KR)

(21) Appl. No.: 18/157,983

(22) Filed: Jan. 23, 2023

(30) Foreign Application Priority Data
Apr. 18, 2022 (KR) 10-2022-0047364

(51) Int. Cl. G06N 3/0495; G06N 3/092

(52) U.S. Cl. CPC G06N 3/092; G06N 3/0495

(57) ABSTRACT

The present disclosure provides a system for accelerating multi-agent reinforcement learning through sparsity processing and an operating method thereof and proposes an acceleration system, which can analyze a weight pruning algorithm capable of guaranteeing accuracy suitably for characteristics of multi-agent reinforcement learning and includes an on-chip encoding unit, a sparse weight workload allocation unit, and sparsity parallel processing architecture through vector processing, which can effectively support the weight pruning algorithm, and an operating method of the system. Furthermore, the present disclosure proposes an acceleration platform that constitutes a circuit in a way to be suitable for a deep learning model from its initial step while having high throughput and power efficiency by using an FPGA, not a GPU in which several thousands of cores have been integrated and which generate many and consume great power.

### CROSS-REFERENCES TO RELATED APPLICATIONS

This application is based on and claims priority under 35 U.S.C. § 119 or 365 to Korean Patent Application No. 10-2022-0047364, filed on Apr. 18, 2022, in the Korean Intellectual Property Office, the disclosures of which are herein incorporated by reference in their entireties.

### TECHNICAL FIELD

The present disclosure relates to a multi-agent reinforcement learning system and an operating method thereof.

### BACKGROUND OF THE DISCLOSURE

Reinforcement learning is one branch of artificial intelligence, and has had a high profile along with supervised learning. Reinforcement learning aims to find, by an agent, a policy to maximize rewards by interacting with an environment unlike another artificial intelligence technology. Deep reinforcement learning in which a deep neural network has been grafted onto reinforcement learning shows excellent performance in various fields, such as game, robotics, and an industry control system, and has been in the spotlight. Recently, multi-agent reinforcement learning that has been extended into several agents from the existing reinforcement learning shows higher accuracy compared to a case in which the number of agents is one, and becomes central in constructing a greater AI system. However, in multi-agent reinforcement learning, all agents require iterative operations while using the same network weight for learning stability, which causes a lot of power consumption in hardware. In addition, recently, as a deep neural network is gradually deepened, network compression algorithms, such as pruning and quantization, have emerged.

In particular, the pruning scheme is a scheme for reducing the size of a network model by using a learning parameter having low importance as 0, and it can omit an operation with respect to a weight having a value of 0 and has an advantage in a hardware aspect of a reduced memory space. However, since most of pruning schemes are researched with respect to supervised learning, an example in which the same pruning scheme has been applied to deep reinforcement learning is not sufficient. In particular, in the case of reinforcement learning, how will a weight removed at the early stage of the learning of a model affect what kind of accuracy cannot be known because a long term decision problem in which a current value is influenced on the state of a future agent is handled. Furthermore, if a weight of multi-agent reinforcement learning is removed, more errors may be caused because weights of all agents are removed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments provide a system for accelerating multi-agent reinforcement learning through sparsity processing and an operating method thereof. An embodiment of the present disclosure proposes an acceleration system, which can analyze a weight pruning algorithm capable of guaranteeing accuracy suitably for characteristics of multi-agent reinforcement learning and includes an on-chip encoding unit, a sparse weight workload allocation unit, and sparsity parallel processing architecture through vector processing, which can effectively support the weight pruning algorithm, and an operating method of the system. Furthermore, an embodiment of the present disclosure proposes an acceleration platform that constitutes a circuit in a way to be suitable for a deep learning model from its initial step while having high throughput and power efficiency by using an FPGA, not a GPU in which several thousands of cores have been integrated and which generate many and consume great power.

In an aspect, a multi-agent reinforcement learning system proposed in the present disclosure includes weight memory configured to initialize and store weights necessary for multi-agent reinforcement learning deep neural network learning and receive learning samples from a PCIe interface, a weight data compression unit configured to generate sparse data including a sparsity vector, a weight-sparse index, and an actual workload by using a weight grouping method when an epoch is started, store the generated sparse data in a row direction weight sparsity data memory, then fetch the weights from the weight memory, compress values of the weights based on a form of the generated sparse data, and transmit only the actual workload and the weight-sparse index to sparsity parallel processing architecture, an instruction scheduler configured to control an entire process of neural network learning including weight grouping, forward propagation, backward propagation, and weight update operations, sparsity parallel processing architecture configured to receive only the actual workload and the weight-sparse index and perform parallel processing within the layer in the entire process of neural network learning, an accumulator configured to add results of pieces of the sparsity parallel processing architecture when an operation of one layer of the sparsity parallel processing architecture is finished, and a workload distributor configured to distribute an input of a next layer to each core by predicting a workload of the next layer.

According to an embodiment of the present disclosure, the system generates the sparse data through the weight-sparse data generation unit during one epoch, compresses the values of the weights through the weight data compression unit based on a form of the generated sparse data and transmits only the actual workload and the weight-sparse index to the sparsity parallel processing architecture, adds the results of the pieces of sparsity parallel processing architecture through the accumulator under the control of the instruction scheduler, repeats an operation method of predicting a workload of a next layer through the workload distributor and distributes the workload to each core, and updates a weight according to the results of the operation.

The weight-sparse data generation unit according to an embodiment of the present disclosure generates each input channel weight group matrix and each output channel weight group matrix with respect to a layer a sparsity of which is to be generated for weight grouping, finds maximum indices in data in the number of groups included in a column of the generated input channel weight group matrices and a row of the generated output channel weight group matrices, and stores and then compares maximum value indices of a column the generated input channel weight group matrices and a row of the generated output channel weight group matrices.

The weight-sparse data generation unit according to an embodiment of the present disclosure compares the maximum value indices of the input channel weight group matrix and the output channel weight group matrix, generates an element of the sparsity vector as 1 when the maximum value indices are identical with each other, generates an element of the sparsity vector as 0 when the maximum value indices are not identical with each other, and stores a location at which the maximum value indices are identical with each other and the number of maximum value indices.

The weight-sparse data generation unit according to an embodiment of the present disclosure generates an input channel weight selection matrix and an output channel weight selection matrix in which a value of the maximum value index is 1 and the rest thereof is 0, with respect to data in the number of groups in a row and column of each of the input channel weight group matrix and the output channel weight group matrix, generates a weight mask matrix having a size identical with a size of the layer the sparsity of which is to be generated, by multiplying the input channel weight selection matrix and the output channel weight selection matrix, uses a corresponding weight in an operation when the value of the weight mask matrix is 1, and does not use the corresponding weight in the epoch when the value of the weight mask matrix is 0.

The workload distributor according to an embodiment of the present disclosure schedules a workload by predicting that workloads are to constantly converge if cores having the same number of weight group matrix columns with respect to the input channel weight group matrix and the output channel weight group matrix generated by the weight-sparse data generation unit, compresses an input and weight of a layer based on the scheduled workload after predicting the workload, and transfers the compressed input and weight to the sparsity parallel processing architecture.

The sparsity parallel processing architecture according to an embodiment of the present disclosure receives only the actual workload and the weight-sparse index, distributes the actual workload and the weight-sparse index to different VPUs based on a weight mask matrix generated by the weight-sparse data generation unit, and distributes a workload by minimizing a fixed connection between VPUs through the VPU because an actual workload is different for each column of the weight mask matrix.

In the sparsity parallel processing architecture according to an embodiment of the present disclosure, the VPU performs parallel processing on a column of a plurality of weight mask matrices, and determines an input to be multiplied by a corresponding weight, among up to four input data, when the four input data is broadcasted by input memory and each weight is unicasted by weight memory.

The sparsity parallel processing architecture according to an embodiment of the present disclosure determines an input to be multiplied by a corresponding weight through the VPU based on an input selection signal generated by using the workload provided by the workload distributor, and simultaneously performs operations on columns of a plurality of weight mask matrices when the input selection signal is changed based on a maximum value index of a column of each weight mask matrix, and performs an operation on a layer having sparsity and a layer not having sparsity.

In another aspect, an operating method of a multi-agent reinforcement learning system proposed in the present disclosure includes receiving, by weight memory, learning samples from a PCIe interface and initializing and storing weights necessary for multi-agent reinforcement learning deep neural network learning, generating, by a weight-sparse data generation unit, sparse data including a sparsity vector, a weight-sparse index, and an actual workload by using a weight grouping method when an epoch is started and storing the generated sparse data in row direction weight sparsity data memory, fetching, by a weight data compression unit, the weights from the weight memory, compressing values of the weights based on a form of the generated sparse data, and transmitting only the actual workload and the weight-sparse index to sparsity parallel processing architecture, controlling, by an instruction scheduler, an entire process of neural network learning including weight grouping, forward propagation, backward propagation, and weight update operations, receiving, by sparsity parallel processing architecture, only the actual workload and the weight-sparse index and performing parallel processing within the layer in the entire process of neural network learning, adding, by an accumulator, results of pieces of the sparsity parallel processing architecture when an operation of one layer of the sparsity parallel processing architecture is finished, and distributing, by a workload distributor, an input of a next layer to each core by predicting a workload of the next layer.

According to embodiments of the present disclosure, through the system for accelerating multi-agent reinforcement learning through sparsity processing and the operating method thereof, a weight pruning algorithm capable of guaranteeing accuracy suitably for characteristics of multi-agent reinforcement learning can be analyzed, and can be effectively supported through the acceleration system, including an on-chip encoding unit, a sparse weight workload allocation unit, and sparsity parallel processing architecture through vector processing. Furthermore, a circuit can be constructed in a way to be suitable for a deep learning model from its initial step while having high throughput and power efficiency by developing the acceleration platform by using an FPGA, not a GPU in which several thousands of cores have been integrated and which generate many and consume great power.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagram illustrating a construction of a system for accelerating multi-agent reinforcement learning according to an embodiment of the present disclosure.

FIG. 2 is a diagram for describing a sparse data on-chip encoding unit using a weight grouping method according to an embodiment of the present disclosure.

FIG. 3 is a diagram for describing a process of the on-chip encoding unit generating weight sparse data according to an embodiment of the present disclosure.

FIG. 4 is a diagram for describing a reduction in the time that is taken for the on-chip encoding unit to generate sparse data according to an embodiment of the present disclosure.

FIG. 5 is a diagram for comparing row direction weight sparsity data memory of the on-chip encoding unit according to an embodiment of the present disclosure and a conventional technology.

FIG. 6 is a diagram for describing a column direction sparse weight workload distributor according to an embodiment of the present disclosure.

FIG. 7 is a diagram for describing sparse weight matrix multiplication according to an embodiment of the present disclosure.

FIG. 8 is a diagram for describing sparsity parallel processing architecture including a vector processing unit (VPU) according to an embodiment of the present disclosure.

FIG. 9 is a diagram for describing a process of generating an input selection signal through the VPU according to an embodiment of the present disclosure.

FIG. 10 is a flowchart for describing an operating method of the system for accelerating multi-agent reinforcement learning according to an embodiment of the present disclosure.

### DETAILED DESCRIPTION

A description of illustrative embodiments follows.

The teachings of all patents, published applications and references cited herein are incorporated by reference in their entirety.

While illustrative embodiments have been illustrated and described, it will be appreciated that various changes can be made therein without departing from the spirit and scope of the disclosure.

Hereinafter, embodiments of the present disclosure are described in detail with reference to the accompanying drawings.

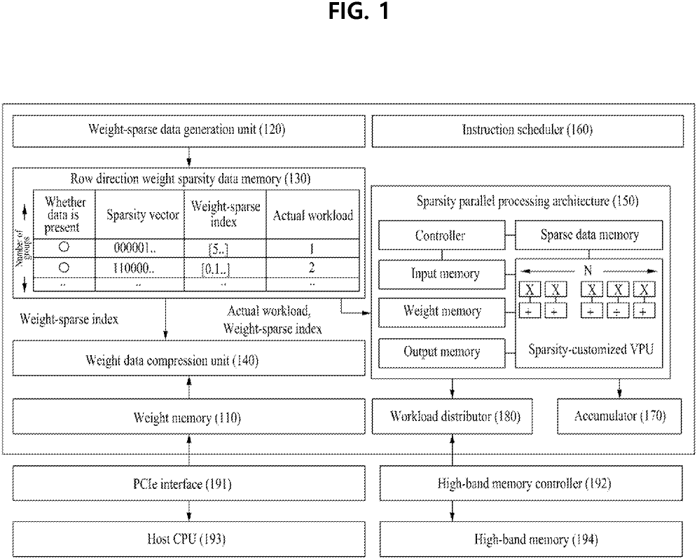

FIG. 1 is a diagram illustrating a construction of a system for accelerating multi-agent reinforcement learning according to an embodiment of the present disclosure.

A proposed system for accelerating multi-agent reinforcement learning includes weight memory 110, a weight-sparse data generation unit 120, a row direction weight sparsity data memory 130, a weight data compression unit 140, sparsity parallel processing architecture 150, an instruction scheduler 160, an accumulator 170, and a workload distributor 180.

The weight memory 110 according to an embodiment of the present disclosure initializes and stores weights necessary for multi-agent reinforcement learning deep neural network learning and receives learning samples from a PCIe interface 191 through a host CPU 193.

The weight-sparse data generation unit 120 according to an embodiment of the present disclosure generates sparse data including a sparsity vector, a weight-sparse index, and an actual workload by using a weight grouping method when an epoch is started, and stores the generated sparse data in the row direction weight sparsity data memory 130.

The weight-sparse data generation unit 120 according to an embodiment of the present disclosure generates each input channel weight group matrix and each output channel weight group matrix with respect to a layer the sparsity of which is to be generated for weight grouping. Thereafter, the weight-sparse data generation unit 120 stores and then compares maximum value indices of the generated input channel weight group matrix and the generated output channel weight group matrix.

The weight-sparse data generation unit 120 according to an embodiment of the present disclosure compares the maximum value indices of the input channel weight group matrix and the output channel weight group matrix, generates an element of the sparsity vector as 1 when the maximum value indices are identical with each other, and stores a location at which the maximum value indices are identical with each other and the number of maximum value indices. In contrast, when the maximum value indices are not identical with each other, the weight-sparse data generation unit 120 generates the element of the sparsity vector as 0.

The weight-sparse data generation unit 120 according to an embodiment of the present disclosure generates an input channel weight selection matrix and an output channel weight selection matrix in which a value of the maximum value index is 1 and the rest thereof is 0, among the maximum value indices of the input channel weight group matrix and the output channel weight group matrix.

Thereafter, the weight-sparse data generation unit 120 generates a weight mask matrix having the same size as the size of the layer the sparsity of which is to be generated by multiplying the input channel weight selection matrix and the output channel weight selection matrix. In this case, the weight-sparse data generation unit 120 uses a corresponding weight in an operation when the value of the weight mask matrix is 1, and does not use the corresponding weight in the epoch when the value of the weight mask matrix is 0.

The weight data compression unit 140 according to an embodiment of the present disclosure fetches the weights from the weight memory, compresses values of the weights based on a form of the generated sparse data, and transmits only the actual workload and the weight-sparse index to sparsity parallel processing architecture.

The sparsity parallel processing architecture 150 according to an embodiment of the present disclosure receives only the actual workload and the weight-sparse index and performs parallel processing within the layer in the entire process (e.g., propagation, reverse propagation, and weight update) of neural network learning.

The sparsity parallel processing architecture 150 according to an embodiment of the present disclosure receives only the actual workload and the weight-sparse index, and distributes the actual workload and the weight-sparse index to different processing units based on a weight mask matrix generated by the weight-sparse data generation unit 120. Since an actual workload is different for each column of the weight mask matrix, the workload is distributed by minimizing a fixed connection between vector processing units (VPUs) through the VPUs.

In the sparsity parallel processing architecture 150 according to an embodiment of the present disclosure, the VPU performs parallel processing on a column of a plurality of weight mask matrices. In this case, when input data is broadcasted by input memory and each weight is unicasted by weight memory, the VPU determines an input to be multiplied by a corresponding weight.

The instruction scheduler 160 according to an embodiment of the present disclosure controls the entire process of neural network learning including weight grouping, forward propagation, backward propagation, and weight update operations.

The accumulator 170 according to an embodiment of the present disclosure adds the results of pieces of the sparsity parallel processing architecture when an operation of one layer of the sparsity parallel processing architecture is finished.

The workload distributor 180 according to an embodiment of the present disclosure distributes the input of a next layer to each core by predicting a workload of the next layer.

As described above, the system for accelerating multi-agent reinforcement learning according to an embodiment of the present disclosure generates the sparse data through the weight-sparse data generation unit 120 during one epoch, compresses the values of the weights through the weight data compression unit 140 based on a form of the generated sparse data, and transmits only an actual workload and a weight-sparse index to the sparsity parallel processing architecture 150. Furthermore, the system for accelerating multi-agent reinforcement learning adds the results of the pieces of sparsity parallel processing architecture through the accumulator 170 under the control of the instruction scheduler 160, repeats an operation method of predicting a workload of a next layer through the workload distributor 180 and distributes the workload to each core, and updates a weight according to the results of the operation. In other words, the system for accelerating multi-agent reinforcement learning repeats the operation method during one epoch, and generates sparse data for a new weight again through the weight-sparse data generation unit 120 when the weight is updated.

The workload distributor 180 according to an embodiment of the present disclosure schedules a workload by predicting that workloads will constantly converge if cores having the same number of weight group matrix columns with respect to the input channel weight group matrix and the output channel weight group matrix generated by the weight-sparse data generation unit 120, compresses the input and weight of a layer based on a corresponding workload after predicting the workload, and transfers the compressed input and weight to the sparsity parallel processing architecture 150.

The sparsity parallel processing architecture 150 according to an embodiment of the present disclosure determines an input to be multiplied by a corresponding weight through the VPU based on an input selection signal generated by using the workload provided by the workload distributor 180.

A high-band memory controller 192 according to an embodiment of the present disclosure generates the selection signal by reading an index list within high-band memory 194 and a workload (in other words, a workload).

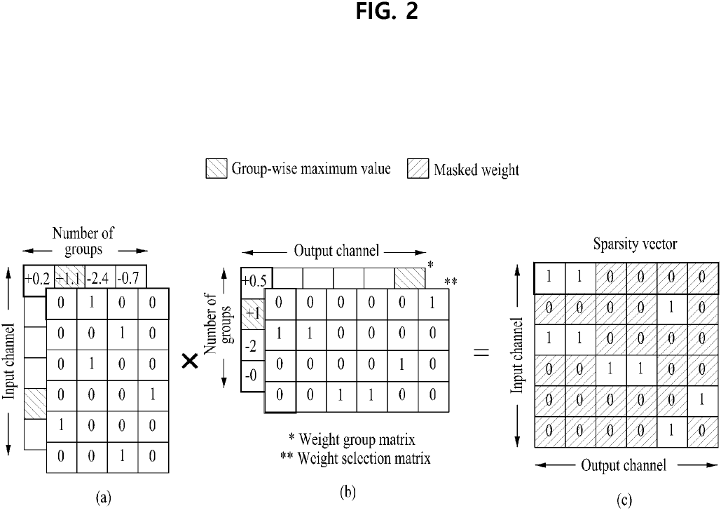

Thereafter, the sparsity parallel processing architecture 150 according to an embodiment of the present disclosure simultaneously performs operations on columns of a plurality of weight mask matrices when the input selection signal is changed based on a maximum value index of a column of each weight mask matrix, and performs an operation on a layer having sparsity and a layer not having sparsity. The components of the system for accelerating multi-agent reinforcement learning according to an embodiment of the present disclosure are more specifically described with reference to FIGS. 2 to 9.

FIG. 2 is a diagram for describing the sparse data on-chip encoding unit using a weight grouping method according to an embodiment of the present disclosure.

FIG. 2(a) is a diagram illustrating maximum values for each group of weight group (IG and OG) matrices according to an embodiment of the present disclosure. FIG. 2(b) is a diagram illustrating the generation of weight selection (IS and OS) matrices through binarization according to an embodiment of the present disclosure. FIG. 2(c) is a diagram illustrating the generation of a weight mask matrix through the multiplication of weight selection matrices according to an embodiment of the present disclosure.

FIG. 2 specifically illustrates how a weight group matrix generates sparsity. Assuming that G is the number of groups, M is an input vector, and N is an output vector, with respect to a layer having an MxN size, which converts the input vector of 1xM into the output vector of 1xN, an input grouping (IG) matrix and an output grouping (OG) matrix set as MxG and GxN, respectively, are created and randomly initialized.

First, a maximum value of data of the number of groups in each row of the IG matrix is found. In other words, only one data is picked up, among groups, in data that corresponds to the number of groups in one row of the IG matrix and one column of the OG matrix. Thereafter, as in a block box in FIG. 2, 1 is assigned to a maximum location and 0 is assigned to the rest, and the input selection (IS) matrix is generated by binarizing each row. Likewise, a maximum value of each column of the OG matrix is found, and the output selection (OS) matrix is generated.

Finally, the mask matrix M is generated by multiplying the IS and OS matrices, so that the IS and OS matrices have the same size as the layer size MXN. A weight grouping algorithm generates a lot of sparsity by using only unmasked weights with reference to a weight mask matrix (i.e., weights in which bits corresponding to a mask are 1). In other words, unnecessary calculation is skipped to a masked weight by reading only an unmasked weight and transmitting the unmasked weight to the core.

Furthermore, values of each group matrix are trained based on errors of a corresponding selection matrix. The weight mask matrix is newly generated when grouping matrices are updated every iteration. A term “bitvector” is used to refer to a row of the mask matrix.

The weight grouping algorithm provides more flexibility than other pruning methods because the weight grouping algorithm trains weight grouping matrices and determines a target to be masked at each iteration. In addition, the level of sparsity may be adjusted based on the number of groups. Most importantly, weight grouping guarantees the accuracy of a model because a mask matrix that changes every iteration has a form equivalent to unstructured pruning. Another benefit of the weight grouping is that original weight values are preserved. Masked weights may be used in next iteration because the masked weight are not set to zero. Efficient sparse data generation and sparse matrix vector multiplication in hardware are proposed by leveraging this flexibility.

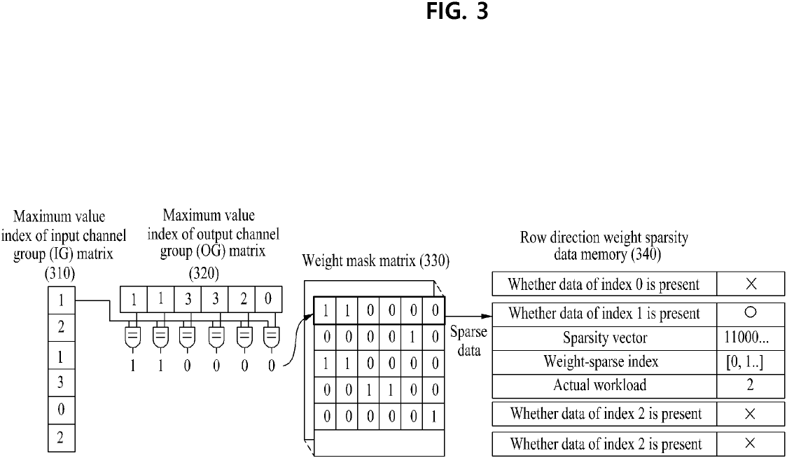

FIG. 3 is a diagram for describing a process of the on-chip encoding unit generating weight sparse data according to an embodiment of the present disclosure.

In the weight grouping method illustrated in FIG. 3, an input channel weight group matrix and output channel weight group matrix of a layer the sparsity of which is to be generated are generate. A maximum value index 310 of the generated input channel weight group matrix (IG) and a maximum value index 320 of the output channel weight group matrix (OG) are found.

The size of each weight group matrix is the number of groups x the size of a channel. After a maximum value is found for each group, a weight selection matrix in which a value of a maximum value index is 1 and the rest thereof is 0. A weight mask matrix 330 having the same size as that of the layer the sparsity of which is to be generated is generated by multiplying the input channel weight selection matrix and the output channel weight selection matrix. When a value of the weight mask matrix 330 is 1, a corresponding weight is used in an operation. When a value of the weight mask matrix 330 is 0, a weight at a corresponding location is not used in an epoch. Sparse data generated as described above is stored in row direction weight sparsity data memory 340.

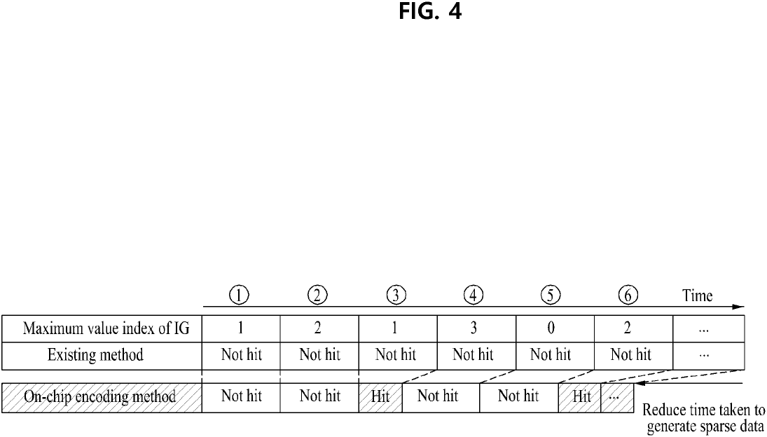

FIG. 4 is a diagram for describing a reduction in the time that is taken for the on-chip encoding unit to generate sparse data according to an embodiment of the present disclosure.

An embodiment of the present disclosure proposes the on-chip encoding unit capable of generating sparse data more effectively when the weight grouping method is used. The present disclosure comes from a characteristic of weight grouping in which the type of sparse data which may be generated is limited to a value that is equal to or smaller than the number of groups. When a weight selection matrix is generated, a maximum value of one of the number of groups to be generated needs to be selected. A process of generating the same sparse data because sparse data generated when maximum value indices are identical with each other are identical with each other may be omitted.

The on-chip encoding unit according to an embodiment of the present disclosure stores and compares maximum value indices of group matrices for each channel. An element of a sparsity vector is set to 1 when the maximum value indices are identical with each other upon comparison, and the element of the sparsity vector is set to 0 when the maximum value indices are not identical with each other upon comparison. A location at which the maximum value indices are identical with each other and the number of maximum value indices that are identical with each other are stored. The location at which the maximum value indices are identical with each other is a weight-sparse index, and is used as an address value when the weight data compression unit actually operates a weight. An actual workload is used to achieve high hardware usage in the sparsity parallel processing architecture. If all of the sparse data are generated with respect to one maximum value index of the input channel weight group matrix, the state in which data of a corresponding index is present or not is changed. With respect to another maximum value index of the input channel weight group matrix, the above process is repeated. If data is already present (in other words, if an index is hit), the process of generating the same sparse data may be omitted.

FIG. 4 illustrates how the on-chip encoding unit is implemented in hardware. A maximum value index of a row of an input grouping (IG) matrix is received every cycle. In cycles 1 and 2, a bitvector is newly generated in each cycle by using the comparator because bitvectors of indices 1 and 2 have not yet been generated in sparse data memory. Thereafter, a sparse data tuple {a bitvector, non-zero indices, a workload} is stored in the sparse data memory. A maximum value index is added to an index list. In a cycle 3, since a maximum index 1 is present in the sparse data memory, the sparse data encoder does not update the tuple, and stores the maximum index in the index list. In cycles 4 and 5, the sparse data memory is updated with respect to indices 3 and 0, respectively. At this point, the sparse row memory stores all of possible bitvectors for G (the number of groups) different rows, and makes a complete mask matrix. Accordingly, the sparse data encoder always hits an index in the sparse data memory, starting from a cycle 6.

With the help of a bitvector of the on-chip encoding unit according to an embodiment of the present disclosure and other row-wise information caching, the sparse data encoder reduces both cycles and an on-chip memory space. For a baseline case not having the on-chip encoding unit, a bitvector is calculated and a sparse row tuple is stored in memory every cycle. The sparse data encoder stores only essential data to on-chip memory, and replaces redundant calculation and a memory footprint by referencing the essential data in the index list.

Furthermore, the sparse data encoder may generate sparse data tuples for training with a simple modification. Since backward propagation uses transposed matrices, an OG matrix is regarded as an IG matrix, and a bitvector is generated by comparing a maximum index of the OG matrix and maximum indices of the IG matrix one by one. Once a bitvector for a row of the transposed matrix is generated, the sparse row memory is updated with non-zero indexes and a workload like inference. The generation of the sparse data tuples for training may operate in parallel to inference computation so that there is no overhead in the system.

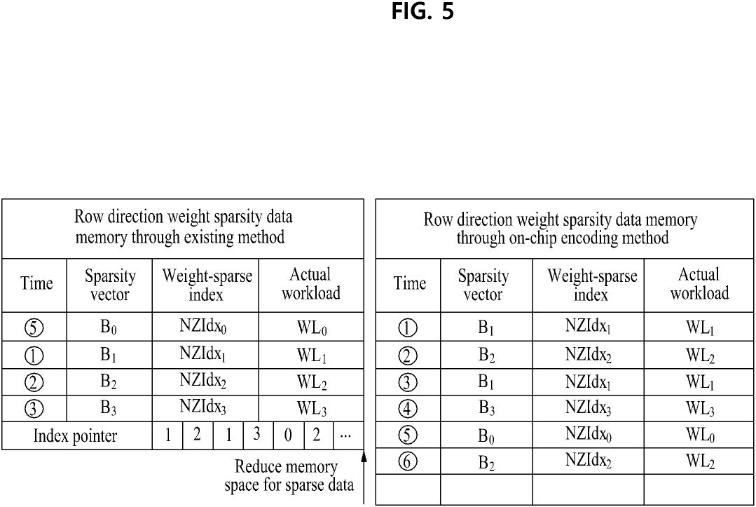

FIG. 5 is a diagram for comparing row direction weight sparsity data memory of the on-chip encoding unit according to an embodiment of the present disclosure and a conventional technology.

The on-chip encoding unit using the weight grouping method according to an embodiment of the present disclosure has advantages from both algorithm and hardware viewpoints. First, in the algorithm viewpoint, the weight grouping method is a sparsity generation method capable of maintaining the accuracy of multi-agent reinforcement learning. In other words, a value of an actual weight is not transmitted as 0, but a weight is selected for each epoch through the learning of a weight group matrix. Accordingly, learning is possible in a more flexible manner compared to the existing sparsity generation method.

Second, in the hardware viewpoint, sparse data encoding using the weight grouping method can reduce the time taken to generate sparse data and can also reduce a memory space in which sparse data is stored. Whether data of a corresponding index is determined by using that the type of sparse data is limited to the number of groups, and new sparse data is generated only when data is not hit. Furthermore, sparse data is identical with a maximum number of groups because only different types of sparse data are stored when the generated sparse data is stored. A storage space for repeated data can be reduced because other data is repeated and only an index pointer is stored.

As described above, according to an embodiment of the present disclosure, by reducing the time and memory necessary to generate sparse data, all the sparse data is generated in the on chip with respect to a weight that varies during the training time of a model, and external memory access can be removed.

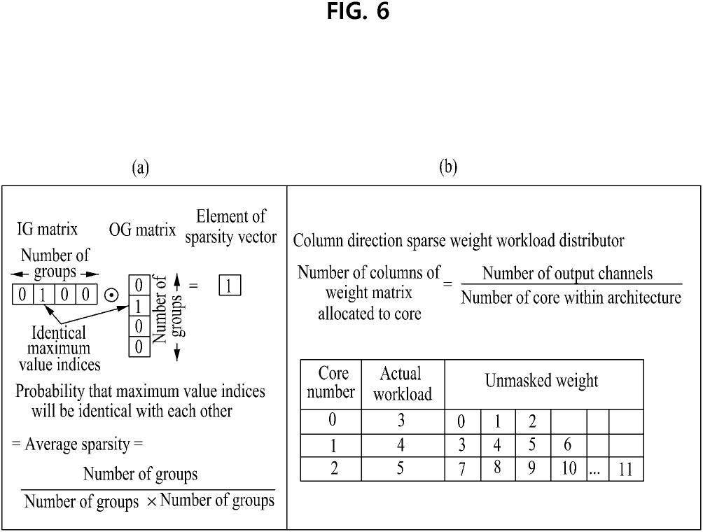

FIG. 6 is a diagram for describing a column direction sparse weight workload distributor according to an embodiment of the present disclosure.

FIG. 6(a) is a diagram for describing a sparsity vector element according to an embodiment of the present disclosure. FIG. 6(b) is a diagram for describing a process of predicting a workload through a column direction sparse weight workload allocation unit (the workload distributor 180 illustrated in FIG. 1) according to an embodiment of the present disclosure.

The workload allocation unit according to an embodiment of the present disclosure also uses that an element of a sparsity vector is generated as 1 only when maximum index values of an input channel weight group matrix and an output channel group matrix are identical with each other. The probability that maximum value indices of the two group matrices are identical with each other becomes average sparsity. The number of 1 in each column (in other words, a sparsity vector) of a weight mask matrix converges on the division of the size of a column by the number of groups.

FIG. 6 illustrates two simple load (in other words, workload) distribution methods. The first method is to use a threshold. Such a method is a method used in most of hardware for sparsity processing, and requires additional logic for predicting a workload. A threshold is set by adding all of unmasked elements (i.e., a total workload) in a weight matrix and then dividing the added result by the number of cores. Thereafter, an unmasked element is distributed to each core element for each row until the number of allocated elements is greater than the threshold.

In the second method, a workload is allocated to each core by equally dividing a row of all matrices by the number of cores. In order to set a bitvector, the probability that a maximum value index of each row of the IG matrix and a maximum value index of each column of the OG matrix are identical with each other may be interpreted as average sparsity of 1/G because the maximum value indices need to be identical with each other. Accordingly, when the allocation unit equally distributes rows of the IG matrix to the cores, a workload of the cores converges on 1/(CxG) of a total workload over time. In this case, C is the number of cores. Such a workload distribution method is simple, but is more effective in the proposed system for accelerating multi-agent reinforcement learning. The proposed acceleration system does not require additional logic in distributing a workload in a row wise because the on-chip encoding unit already generates a sparse data tuple in a row wise. Furthermore, such a method may directly use parallel processing within a layer because a workload of a single layer is distributed to several cores in a row direction.

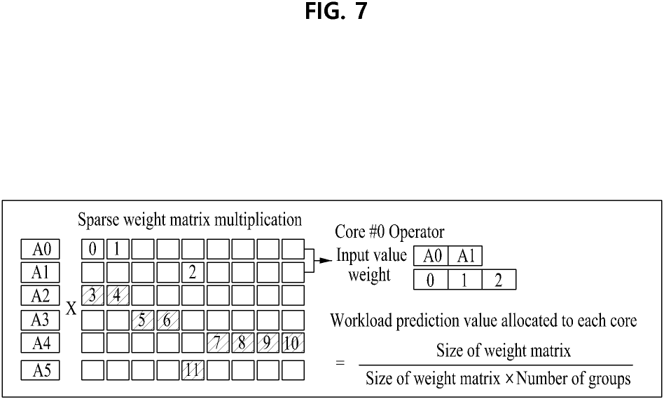

FIG. 7 is a diagram for describing sparse weight matrix multiplication according to an embodiment of the present disclosure.

As described above with reference to FIG. 6, the column direction sparse weight workload allocation unit predicts that a workload will constantly converge if cores have the same number of weight matrix columns with respect to a weight matrix, and schedules an operation. After predicting the workload, the column direction sparse weight workload allocation unit compresses the input and weight of a layer suitably for the workload and transfers the compressed input and weight to the sparsity parallel processing architecture. As described above, if the column direction sparse weight workload allocation unit according to an embodiment of the present disclosure is used, there is an advantage in that a workload can be simply scheduled without an additional hardware module.

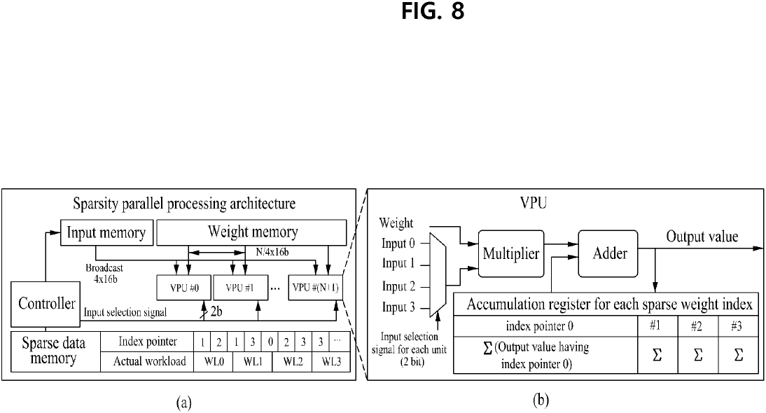

FIG. 8 is a diagram for describing the sparsity parallel processing architecture including a VPU according to an embodiment of the present disclosure.

FIG. 8(a) is a diagram illustrating the sparsity parallel processing architecture according to an embodiment of the present disclosure. FIG. 8(b) is a diagram illustrating a VPU according to an embodiment of the present disclosure.

The sparsity parallel processing architecture that efficiently supports the entire predicting and learning process of multi-agent reinforcement learning including sparsity processing is more specifically described with reference to FIG. 8.

The sparsity parallel processing architecture according to an embodiment of the present disclosure receives only data to be actually operated from the column direction workload distributor and the weight data compression unit by considering sparsity, and stores the data in the input memory and the weight memory. In the training of a model in which sparsity has been considered, weights need to be distributed to different processing units based on a mask matrix. An actual workload is different in each column of a weight matrix. Accordingly, unlike in the existing 2-D array processor, in an embodiment of the present disclosure, a fixed connection between the processing units is minimized and a workload is distributed more efficiently by using the processing unit having a vector form.

FIG. 8 illustrates architecture of a learning group core in which the sparsity parallel processing architecture including a VPU according to an embodiment of the present disclosure includes a core controller, input memory, weight memory, sparse data memory, and N dense /sparse VPUs. Activation and weight memory stores activation and packed weight data distributed from the direction sparse weight workload allocation unit. The sparse data memory stores an unmasked weight and an index indicative of a sparse data tuple received from the sparse data encoder, which needs to be actually operated in each core, for each column of each weight. According to an embodiment of the present disclosure, the core controller broadcasts four 16-bit input data to the VPUs and loads weights from the weight memory during four cycles. A main feature of the learning group core is to process up to four rows which have different workloads at the same time. Since the weights for multiple rows are already packed by the weight compression unit and loaded, each VPU just needs to select a right activation to fetch out of the four broadcasted activations. For this, the core controller generates an input selection signal by reading an index list and workload in the sparse data memory. An input selection signal matrix of the VPU is made by workload numbers. The number WL0 of VPUs selects Activation0, and the number WL1 of VPUs selects Activation1. By packing up to four rows into the VPUs and performing multiply-and-accumulate (MAC) in parallel, the core can achieve high throughput and utilization.

Each VPU according to an embodiment of the present disclosure includes an FP16 multiplier, an FP16 adder, and a 4-to-1 multiplexer. Each VPU can store a weight value while receiving four activations from the activation memory as an input, so that multi-row processing stays constantly until the multi-row processing is finished. Each VPU has four separate accumulation registers each of which can be accumulated separately in accordance with a row index. The number of VPUs, that is, N, is selected as 264 by considering a network dimension and the amount of shifting for select signal generation. In this configuration, the learning group core shows high computing utilization of 86.96 and 96.89% on average for dense and sparse layers, respectively.

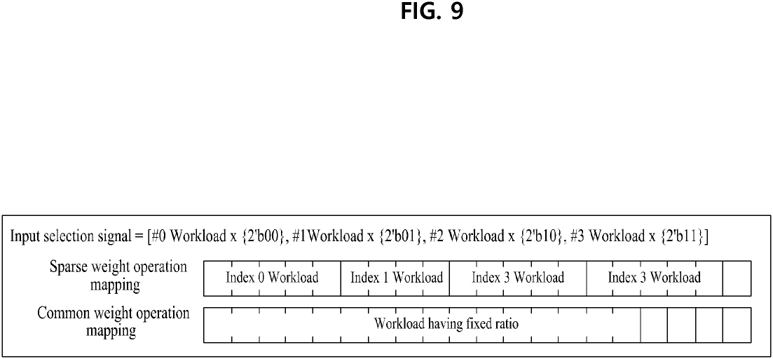

FIG. 9 is a diagram for describing a process of generating an input selection signal through the VPU according to an embodiment of the present disclosure.

The VPU according to an embodiment of the present disclosure may process a column of up to four weight matrices. For example, when four 16-bit inputs is broadcasted by the input memory and weights area unicasted by the weight memory, the VPU determines that a corresponding weight and which input will be multiplied. This is performed based on an input selection signal generated by using a workload provided by the column direction workload distributor. A workload corresponding to a maximum number of groups is present, and the input selection signal is changed depending on that a column of each weight matrix has what maximum value index. Accordingly, operations can be simultaneously performed on a maximum of four workloads, that is, four columns. Operations can be performed on both a layer having sparsity and a layer not having sparsity with high hardware usage.

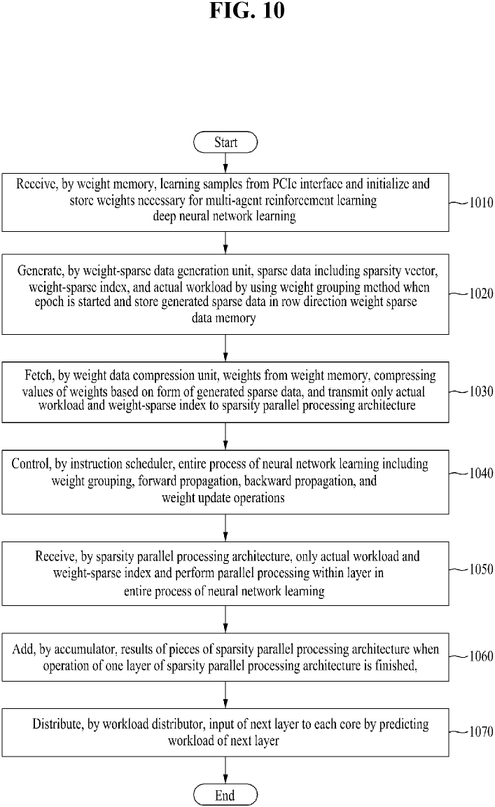

FIG. 10 is a flowchart for describing an operating method of the system for accelerating multi-agent reinforcement learning according to an embodiment of the present disclosure.

A proposed operating method of the system for accelerating multi-agent reinforcement learning includes step 1010 of receiving, by weight memory, learning samples from a PCIe interface and initializing and storing weights necessary for multi-agent reinforcement learning deep neural network learning, step 1020 of generating, by a weight-sparse data generation unit, sparse data including a sparsity vector, a weight-sparse index, and an actual workload by using a weight grouping method when an epoch is started and storing the generated sparse data in a row direction weight sparsity data memory, step 1030 of fetching, by a weight data compression unit, the weights from the weight memory, compressing values of the weights based on a form of the generated sparse data, and transmitting only the actual workload and the weight-sparse index to sparsity parallel processing architecture, step 1040 of controlling, by an instruction scheduler, an entire process of neural network learning including weight grouping, forward propagation, backward propagation, and weight update operations, step 1050 of receiving, by sparsity parallel processing architecture, only the actual workload and the weight-sparse index and performing parallel processing within the layer in the entire process (e.g., propagation, reverse propagation, and weight update) of neural network learning, step 1060 of adding, by an accumulator, results of pieces of the sparsity parallel processing architecture when an operation of one layer of the sparsity parallel processing architecture is finished, and step 1070 of distributing, by a workload distributor, an input of a next layer to each core by predicting a workload of the next layer.

In step 1010, the weight memory receives learning samples from the PCIe interface and initializes and stores weights necessary for multi-agent reinforcement learning deep neural network learning.

In step 1020, the weight-sparse data generation unit generates sparse data including a sparsity vector, a weight-sparse index, and an actual workload by using the weight grouping method when an epoch is started, and stores the generated sparse data in the row direction weight sparsity data memory.

The weight-sparse data generation unit according to an embodiment of the present disclosure generates each input channel weight group matrix and each output channel weight group matrix with respect to a layer the sparsity of which is to be generated for weight grouping. Thereafter, the weight-sparse data generation unit stores and then compares maximum value indices of the generated input channel weight group matrix and the generated output channel weight group matrix.

The weight-sparse data generation unit according to an embodiment of the present disclosure compares the maximum value indices of the input channel weight group matrix and the output channel weight group matrix, generates an element of the sparsity vector as 1 when the maximum value indices are identical with each other, and stores a location at which the maximum value indices are identical with each other and the number of maximum value indices. In contrast, when the maximum value indices are not identical with each other, the weight-sparse data generation unit generates the element of the sparsity vector as 0.

The weight-sparse data generation unit according to an embodiment of the present disclosure generates an input channel weight selection matrix and an output channel weight selection matrix in which a value of the maximum value index is 1 and the rest thereof is 0, among the maximum value indices of the input channel weight group matrix and the output channel weight group matrix.

Thereafter, the weight-sparse data generation unit generates a weight mask matrix having the same size as the size of the layer the sparsity of which is to be generated by multiplying the input channel weight selection matrix and the output channel weight selection matrix. In this case, the weight-sparse data generation unit uses a corresponding weight in an operation when the value of the weight mask matrix is 1, and does not use the corresponding weight in the epoch when the value of the weight mask matrix is 0.

In step 1030, the weight data compression unit fetches the weights from the weight memory, compresses values of the weights based on a form of the generated sparse data, and transmits only the actual workload and the weight-sparse index to sparsity parallel processing architecture.

In step 1040, the instruction scheduler controls the entire process of neural network learning including weight grouping, forward propagation, backward propagation, and weight update operations.

In step 1050, the sparsity parallel processing architecture receives only the actual workload and the weight-sparse index and performs parallel processing within the layer in the entire process of neural network learning.

The sparsity parallel processing architecture according to an embodiment of the present disclosure receives only the actual workload and the weight-sparse index, and distributes the actual workload and the weight-sparse index to different processing units based on a weight mask matrix generated by the weight-sparse data generation unit 120. Since an actual workload is different for each column of the weight mask matrix, the workload is distributed by minimizing a fixed connection between vector processing units (VPUs) through the VPUs.

In the sparsity parallel processing architecture according to an embodiment of the present disclosure, the VPU performs parallel processing on a column of a plurality of weight mask matrices. In this case, when input data is broadcasted by the input memory and each weight is unicasted by the weight memory, the VPU determines an input to be multiplied by a corresponding weight.

In step 1060, the accumulator adds the results of pieces of the sparsity parallel processing architecture when an operation of one layer of the sparsity parallel processing architecture is finished.

In step 1070, the workload distributor distributes the input of a next layer to each core by predicting a workload of the next layer.

As described above, the system for accelerating multi-agent reinforcement learning according to an embodiment of the present disclosure generates the sparse data through the weight-sparse data generation unit during one epoch, compresses the values of the weights through the weight data compression unit based on a form of the generated sparse data, and transmits only an actual workload and a weight-sparse index to the sparsity parallel processing architecture. Furthermore, the system for accelerating multi-agent reinforcement learning adds the results of the pieces of sparsity parallel processing architecture through the accumulator under the control of the instruction scheduler, repeats an operation method of predicting a workload of a next layer through the workload distributor and distributes the workload to each core, and updates a weight according to the results of the operation.

The workload distributor according to an embodiment of the present disclosure schedules a workload by predicting that workloads will constantly converge if cores having the same number of weight group matrix columns with respect to the input channel weight group matrix and the output channel weight group matrix generated by the weight-sparse data generation unit, compresses the input and weight of a layer based on a corresponding workload after predicting the workload, and transfers the compressed input and weight to the sparsity parallel processing architecture.

The sparsity parallel processing architecture according to an embodiment of the present disclosure determines an input to be multiplied by a corresponding weight through the VPU based on an input selection signal generated by using the workload provided by the workload distributor.

Thereafter, the sparsity parallel processing architecture according to an embodiment of the present disclosure simultaneously performs operations on columns of a plurality of weight mask matrices when the input selection signal is changed based on a maximum value index of a column of each weight mask matrix, and performs an operation on a layer having sparsity and a layer not having sparsity.

The aforementioned device may be implemented as a hardware component, a software component, or a combination of a hardware component and a software component. For example, the device and component described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, a component, a physical device, virtual equipment, or a computer storage medium or device in order to be interpreted by the processing device or to provide an instruction or data to the processing device. The software may be distributed to computer systems that are connected over a network, and may be stored or executed in a distributed manner. The software and the data may be stored in one or more computer-readable recording media.

The method according to an embodiment may be implemented in the form of a program instruction executable by various computer means and stored in a computer-readable medium. The computer-readable recording medium may include a program instruction, a data file, and a data structure solely or in combination. The program instruction recorded on the medium may be specially designed and constructed for an embodiment, or may be known and available to those skilled in the computer software field. Examples of the computer-readable recording medium include magnetic media such as a hard disk, a floppy disk and a magnetic tape, optical media such as CD-ROM and a DVD, magneto-optical media such as a floptical disk, and hardware devices specially configured to store and execute a program instruction, such as ROM, RAM, and a flash memory. Examples of the program instruction include a high-level language code executable by a computer by using an interpreter in addition to a machine-language code, such as that written by a compiler.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as a system, a structure, a device, and a circuit, are coupled or combined in a form different from that of the described method or replaced or substituted with other components or equivalents thereof.

Accordingly, other implementations, other embodiments, and the equivalents of the claims fall within the scope of the claims.

What is claimed is:

1. A system for accelerating multi-agent reinforcement learning, comprising:
weight memory configured to initialize and store weights necessary for multi-agent reinforcement learning deep neural network learning and receive learning samples from a PCIe interface;
a weight-sparse data generation unit configured to generate sparse data comprising a sparsity vector, a weight-sparse index, and an actual workload by using a weight grouping method when an epoch is started and to store the generated sparse data in a row direction weight sparsity data memory;
a weight data compression unit configured to fetch the weights from the weight memory, compress values of the weights based on a form of the generated sparse data, and transmit only the actual workload and the weight-sparse index to sparsity parallel processing architecture;
an instruction scheduler configured to control an entire process of neural network learning comprising weight grouping, forward propagation, backward propagation, and weight update operations;
sparsity parallel processing architecture configured to receive only the actual workload and the weight-sparse index and perform parallel processing within the layer in the entire process of neural network learning;
an accumulator configured to add results of pieces of the sparsity parallel processing architecture when an operation of one layer of the sparsity parallel processing architecture is finished; and
a workload distributor configured to distribute an input of a next layer to each core by predicting a workload of the next layer.

2. The system of claim 1, wherein the system
generates the sparse data through the weight-sparse data generation unit during one epoch,
compresses the values of the weights through the weight data compression unit based on a form of the generated sparse data and transmits only the actual workload and the weight-sparse index to the sparsity parallel processing architecture,
adds the results of the pieces of sparsity parallel processing architecture through the accumulator under the control of the instruction scheduler,
repeats an operation method of predicting a workload of a next layer through the workload distributor and distributes the workload to each core, and
updates a weight according to the results of the operation.

3. The system of claim 1, wherein the weight-sparse data generation unit
generates each input channel weight group matrix and each output channel weight group matrix with respect to a layer a sparsity of which is to be generated for weight grouping,
finds maximum indices in data in the number of groups included in a column of the generated input channel weight group matrices and a row of the generated output channel weight group matrices, and
stores and then compares maximum value indices of a column the generated input channel weight group matrices and a row of the generated output channel weight group matrices.

4. The system of claim 3, wherein the weight-sparse data generation unit
compares the maximum value indices of the input channel weight group matrix and the output channel weight group matrix,
generates an element of the sparsity vector as 1 when the maximum value indices are identical with each other,
generates an element of the sparsity vector as 0 when the maximum value indices are not identical with each other, and
stores a location at which the maximum value indices are identical with each other and the number of maximum value indices.

5. The system of claim 4, wherein the weight-sparse data generation unit
generates an input channel weight selection matrix and an output channel weight selection matrix in which a value of the maximum value index is 1 and the rest thereof is 0, among the maximum value indices of the input channel weight group matrix and the output channel weight group matrix,
generates a weight mask matrix having a size identical with a size of the layer the sparsity of which is to be generated, by multiplying the input channel weight selection matrix and the output channel weight selection matrix,
uses a corresponding weight in an operation when the value of the weight mask matrix is 1, and
does not use the corresponding weight in the epoch when the value of the weight mask matrix is 0.

6. The system of claim 1, wherein the workload distributor
schedules a workload by predicting that workloads are to constantly converge if cores having the same number of weight group matrix columns with respect to the input channel weight group matrix and the output channel weight group matrix generated by the weight-sparse data generation unit,
compresses an input and weight of a layer based on the scheduled workload after predicting the workload, and
transfers the compressed input and weight to the sparsity parallel processing architecture.

7. The system of claim 1, wherein the sparsity parallel processing architecture
receives only the actual workload and the weight-sparse index,
distributes the actual workload and the weight-sparse index to different VPUs based on a weight mask matrix generated by the weight-sparse data generation unit, and
distributes a workload by minimizing a fixed connection between VPUs through the VPU because an actual workload is different for each column of the weight mask matrix.

8. The system of claim 7, wherein in the sparsity parallel processing architecture, the VPU performs parallel processing on a column of a plurality of weight mask matrices, and determines an input to be multiplied by a corresponding weight when input data is broadcasted by input memory and each weight is unicasted by weight memory.

9. The system of claim 8, wherein the sparsity parallel processing architecture
determines an input to be multiplied by a corresponding weight through the VPU based on an input selection signal generated by using the workload provided by the workload distributor, and
simultaneously performs operations on columns of a plurality of weight mask matrices when the input selection signal is changed based on a maximum value index of a column of each weight mask matrix, and performs an operation on a layer having sparsity and a layer not having sparsity.

10. An operating method of a system for accelerating multi-agent reinforcement learning, the operating method comprising:
receiving, by weight memory, learning samples from a PCIe interface and initializing and storing weights necessary for multi-agent reinforcement learning deep neural network learning;
generating, by a weight-sparse data generation unit, sparse data comprising a sparsity vector, a weight-sparse index, and an actual workload by using a weight grouping method when an epoch is started and storing the generated sparse data in a row direction weight sparsity data memory;
fetching, by a weight data compression unit, the weights from the weight memory, compressing values of the weights based on a form of the generated sparse data, and transmitting only the actual workload and the weight-sparse index to sparsity parallel processing architecture;
controlling, by an instruction scheduler, an entire process of neural network learning comprising weight grouping, forward propagation, backward propagation, and weight update operations;
receiving, by sparsity parallel processing architecture, only the actual workload and the weight-sparse index and performing parallel processing within the layer in the entire process of neural network learning;
adding, by an accumulator, results of pieces of the sparsity parallel processing architecture when an operation of one layer of the sparsity parallel processing architecture is finished; and
distributing, by a workload distributor, an input of a next layer to each core by predicting a workload of the next layer.

11. The operating method of claim 10, further comprising generating the sparse data through the weight-sparse data generation unit during one epoch, compressing the values of the weights through the weight data compression unit based on a form of the generated sparse data and transmitting only the actual workload and the weight-sparse index to the sparsity parallel processing architecture, adding the results of the pieces of sparsity parallel processing architecture through the accumulator under the control of the instruction scheduler, repeating an operation method of predicting a workload of a next layer through the workload distributor and distributing the workload to each core, and updating a weight according to the results of the operation.

12. The operating method of claim 10, wherein generating, by a weight-sparse data generation unit, sparse data comprising a sparsity vector, a weight-sparse index, and an actual workload by using a weight grouping method when an epoch is started and storing the generated sparse data in a row direction weight sparsity data memory, comprises:
generating each input channel weight group matrix and each output channel weight group matrix with respect to a layer a sparsity of which is to be generated for weight grouping,
finding maximum indices in data in the number of groups included in a column of the generated input channel weight group matrices and a row of the generated output channel weight group matrices, and
storing and then comparing maximum value indices of a column the generated input channel weight group matrices and a row of the generated output channel weight group matrices.

13. The operating method of claim 12, wherein:
the maximum value indices of the input channel weight group matrix and the output channel weight group matrix are compared,
an element of the sparsity vector is generated as 1 when the maximum value indices are identical with each other,
an element of the sparsity vector is generated as 0 when the maximum value indices are not identical with each other, and
a location at which the maximum value indices are identical with each other and the number of maximum value indices are stored.

14. The operating method of claim 13, wherein:
an input channel weight selection matrix and an output channel weight selection matrix in which a value of the maximum value index is 1 and the rest thereof is 0, among the maximum value indices of the input channel weight group matrix and the output channel weight group matrix, are generated,
a weight mask matrix having a size identical with a size of the layer the sparsity of which is to be generated is generated by multiplying the input channel weight selection matrix and the output channel weight selection matrix,
a corresponding weight is used in an operation when the value of the weight mask matrix is 1, and
the corresponding weight is not used in the epoch when the value of the weight mask matrix is 0.

15. The operating method of claim 10, wherein distributing, by a workload distributor, an input of a next layer to each core by predicting a workload of the next layer comprises:
scheduling a workload by predicting that workloads are to constantly converge if cores having the same number of weight group matrix columns with respect to the input channel weight group matrix and the output channel weight group matrix generated by the weight-sparse data generation unit,
compressing an input and weight of a layer based on the scheduled workload after predicting the workload, and
transferring the compressed input and weight to the sparsity parallel processing architecture.

16. The operating method of claim 10, wherein receiving, by sparsity parallel processing architecture, only the actual workload and the weight-sparse index and performing parallel processing within the layer in the entire process of neural network learning comprises:
receiving only the actual workload and the weight-sparse index,
distributing the actual workload and the weight-sparse index to different VPUs based on a weight mask matrix generated by the weight-sparse data generation unit, and
distributing a workload by minimizing a fixed connection between VPUs through the VPU because an actual workload is different for each column of the weight mask matrix.

17. The operating method of claim 16, wherein the VPU performs parallel processing on a column of a plurality of weight mask matrices, and determines an input to be multiplied by a corresponding weight when input data is broadcasted by input memory and each weight is unicasted by weight memory.

18. The operating method of claim 17, wherein:
an input to be multiplied by a corresponding weight is determined through the VPU based on an input selection signal generated by using the workload provided by the workload distributor, and
an operation is simultaneously performed on a column of a plurality of weight mask matrices when the input selection signal is changed based on a maximum value index of a column of each weight mask matrix, and an operation is performed on a layer having sparsity and a layer not having sparsity.
